(19) United States
(12) Patent Application Publication
(10) Pub. No.: US 2012/0296714 A1
(43) Pub. Date: Nov. 22, 2012

(54) GiveBackMail

(76) Inventors: Sam Yadegar, Los Angeles, CA (US); Rambod Yadegar, Los Angeles, CA (US)

(21) Appl. No.: 13/109,204

(22) Filed: May 17, 2011

(51) Int. Cl. G06Q 30/00

(52) U.S. Cl. 705/14.7; 705/14.4

(57) ABSTRACT

Preferred embodiments of an email service or system that derives revenues from advertisements displayed on the user interface of an email client, wherein at least a portion of any advertising revenues derived from the user's use of the email client are donated to a charity of the user's choice.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of Invention.

The invention relates to email, email systems, charitable donations, and methods of accomplishing a charitable donation.

2. Background.

Charity may be thought of as the practice of a donor giving goods, services, or money to those in need. Goods, services, or money given for charity are known as charitable donations. In some cases, charitable donations are collected by charitable organizations that apply the donation to a particular charitable purpose. Frequently, individuals are desirous of making charitable donations, but nevertheless do not have the time, money, energy, or know-how to accomplish such a bequest. As a result, there is a need for systems and methods of accomplishing a charitable donation that are both (a) low or no cost (in time, money, and energy) to the donor and (b) readily apparent to the donor.

One proposed solution to the identified need is disclosed in the patent family of U.S. Pat. No. 7,769,738 (issued Aug. 3, 2010) and U.S. Pat. No. 7,895,182 (issued Feb. 22, 2011) and understood by applicant to be embodied by www.goodsearch.com. In said proposed solution (hereinafter “goodsearch method”), a portion of advertising revenues derived from the use of an internet search engine by a user is provided to a charitable organization of the user's choice. See www.goodsearch.com/about.aspx#faq2. Although the goodsearch method accomplishes a charitable donation with no financial cost to the user and in a manner that is readily apparent to most individuals in the internet age, the method is not entirely satisfactory in view of the above identified need because: (1) the method is time consuming since a user must identify its chosen charitable organization each time the user resets the search engine or accesses the search engine from another computer; and, (2) the method is limited since charitable donations are only accomplished whenever the user takes one of many possible actions on the search engine homepage or throughout the day. Accordingly, there remains a need for systems and methods of accomplishing a charitable donation that are both (a) low or no cost (in time, money, and energy) to the donor and (b) readily apparent to the donor.

### SUMMARY OF THE INVENTION

In view of the foregoing, it is an object of this application to disclose systems and methods of accomplishing a charitable donation that are both (a) low or no cost (in time, money, and energy) to the donor and (b) readily apparent to the donor. To meet this objective, this disclosure generally describes preferred embodiments of an email service or system that derives revenues from advertisements displayed on the user interface of an email client, wherein at least a portion of any advertising revenues derived from the user's use of the email client are donated to a charity of the user's choice.

### BRIEF DESCRIPTION OF THE FIGURES

The manner in which these objectives and other desirable characteristics can be obtained is better explained in the following description and attached figures in which:

FIG. 1 is a preferable MUA user interface for a user to register for an email account;

FIG. 2 is a preferable MUA user interface for a user to select a charity to be associated with the account;

FIG. 3 is a preferable MUA user interface for a user to input identity information;

FIG. 4 is a preferable MUA user interface showing a user emailbox;

FIG. 5 is a preferable MUA user interface showing an incoming email message;

FIG. 6 is a preferable MUA user interface for composing an outgoing email message;

FIG. 7 is a preferable MUA user interface for manipulating the preferences of the email account;

FIG. 8. Is a preferable MUA user interface for displaying contact information;

FIG. 9 is a preferable MUA user interface for displaying calendar information;

It is to be noted, however, that the appended figures illustrate only typical embodiments disclosed in this application, and therefore, are not to be considered limiting of its scope, for the invention may admit to other equally effective embodiments that will be appreciated by those reasonably skilled in the relevant arts. The components in the figures are not necessarily to scale, with an emphasis instead being placed upon illustrating the principles of the invention. In the figures, like reference numerals designate corresponding parts throughout the different views.

### DETAILED DESCRIPTION OF PREFERRED EMBODIMENTS

This disclosure describes preferred embodiments of an email service or system that derives revenues from advertisements displayed on the user interface of an email client, wherein at least a portion of any advertising revenues derived from the user's use of the email client are donated to a charity of the user's choice. In a preferred embodiment, a user of the email system may create an email account, which account is associated with an email address (e.g., an emailbox (local address) and a domain name) and a charitable organization. Suitably, the account may be accessed by the user via an email client or mail user agent (MUA), which provides the user with an interface for managing, among other things, incoming messages in the emailbox and outgoing email messages. In an optional embodiment, the MUA may provide an interface for managing calendars or contacts. Preferably, advertisements may be provided on the various user interfaces of the email client or MUA so that the advertisements refresh or change as the user interacts with the user interface. For instance, the advertisement may refresh or change after a user opens the MUA user interface for composing a mail or after a composed mail has be sent. Suitably, advertising revenues may be generated with each presentation or refreshment of an advertisement on the MUA or email client user interface. In other words, actions taken by the user result in a change or refresh of the advertisement and therefore, generate advertising revenues. At least a portion of the advertising revenues may be donated to the charitable organization associated with the account. In one embodiment the user agrees to use the email client in exchange for the email service provider donating a portion of the advertising revenues to the charitable organization of the user's choice.

A primary aspect of the disclosed email system is the MUA or email client (hereinafter MUA). The MUA is preferably defined by programming code on computer readable memory. Any design methodology may be utilized to implement a design for embodiments of the MUA, including but not limited to, object oriented design. Any programming language may be utilized to implement the program code of the MUA including any high level language, assembly language or microcode.

In one preferable embodiment, a user may register for an email account via the MUA, which account is associated with an email address and a charitable organization selected by the user. To wit, the programming code of the MUA must be configured to: display a user interface on a terminal (e.g., computer monitor, or phone display); create a new emailbox or locate an unused emailbox; receive inputs via the user interface of an indication of identifying information of the user and associate said identifying information with the emailbox; receive inputs via the user interface of at least one indication of identifying information for a charitable organization; and populate a database with the indications of information of the user and charitable organization in association with each other and an indication of identifying information of the emailbox. The database may preferably used so that the user may login to the created email account by inputting an indication of identifying information to be found in the population of the database whereby the user may access the corresponding emailbox and manage the account via the MUA.

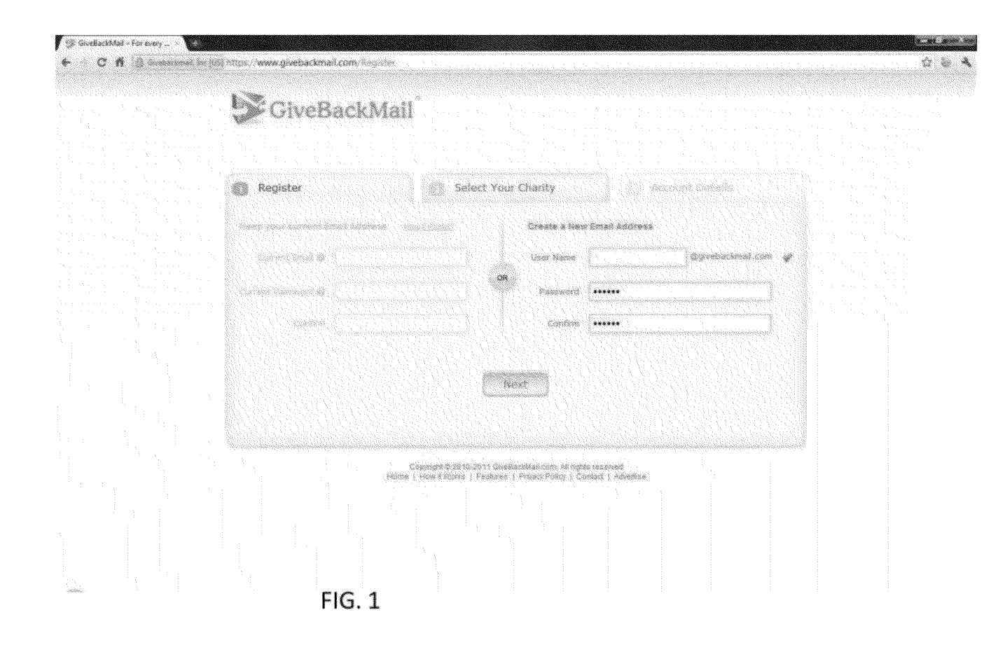

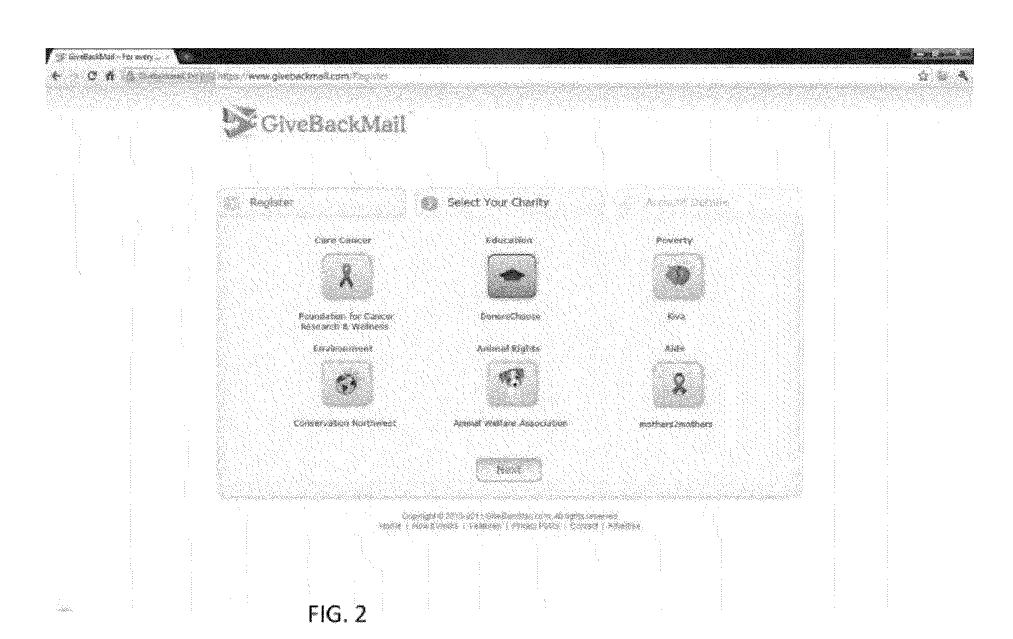

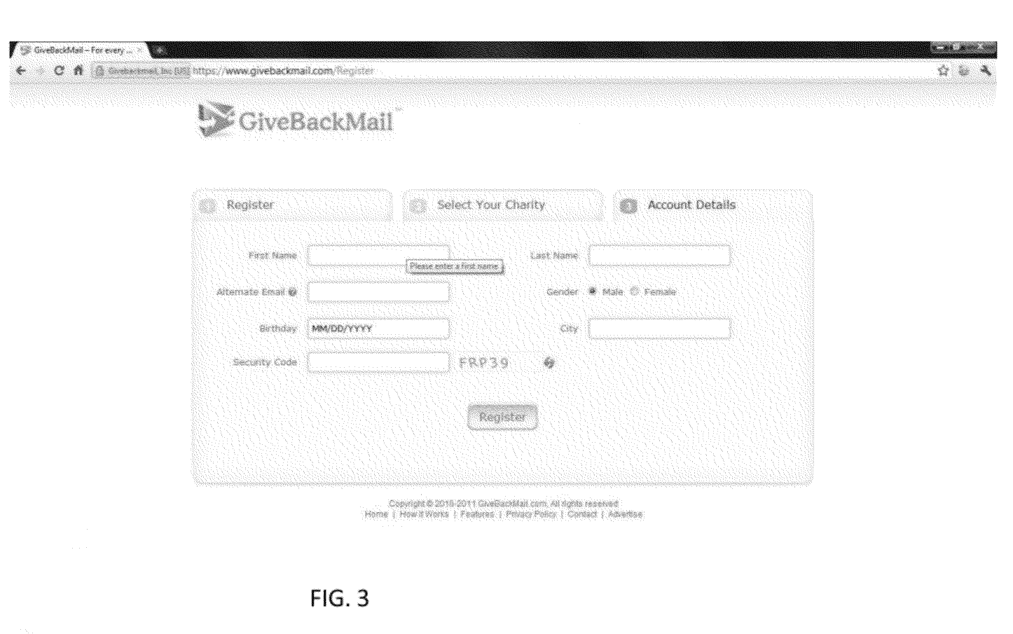

FIGS. 1 through 3 are exemplary interfaces of an MUA that may be used to create an email account as set forth above. As shown in the figures, the interface presents various text entry boxes, dialog boxes, and/or command buttons to collect the necessary user's input of indications of identifying information. An exemplary logic flow for accomplishing account creation may be, as follows: receive an input of an indication of identifying information from the user; examine the population of a database populated with indications of users in association with an indication of information of an emailbox and charitable organization, wherein IF the input of the identifying information is among the database population, THEN the associated indication of identifying information of the emailbox is used to determine and access the emailbox, ELSE a new emailbox is created, an input of an indication of an identifying charitable organization is received, the database is populated with the indication of identifying information of the user in association with the indication of identifying information of the charitable organization and an indication of identifying information of the emailbox.

In the preferable embodiment, the MUA accesses the user's emailbox and displays various interfaces for composing outgoing messages and managing the emailbox and email account. Composing messages may require the program code of the MAU to be configured to, among other things: present a user interface for composing a message; convert composed messages into an email format; save drafts of composed messages; and, transmit sent composed messages via a submission protocol (e.g., simple mail transfer protocol (SMTP)). Managing the emailbox and account may require the program code to be configured to: display, sort, delete, and save incoming messages; display, sort, delete, and save outgoing messages, including drafts; display, sort, delete, and save contacts or calendared events. Such configurations of software or programming code for composing outgoing messages and managing the emailbox and email accounts are well known by those of skill in the art.

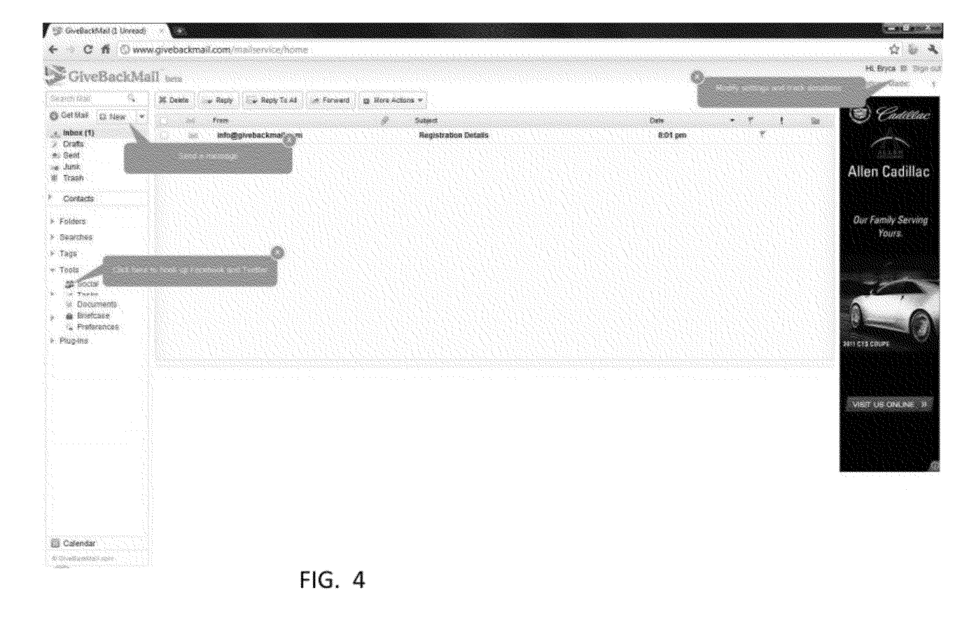

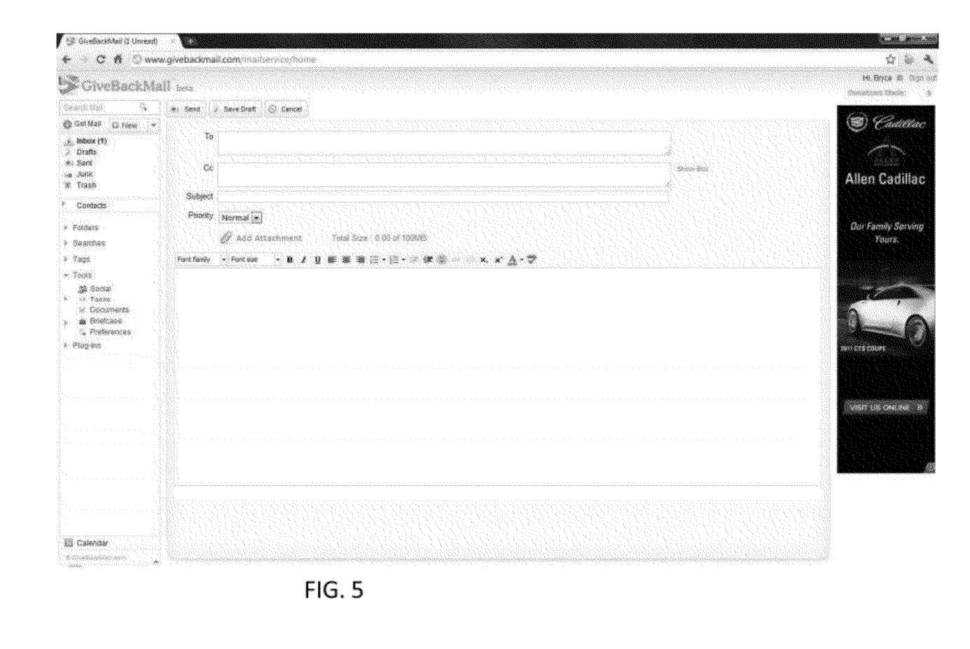

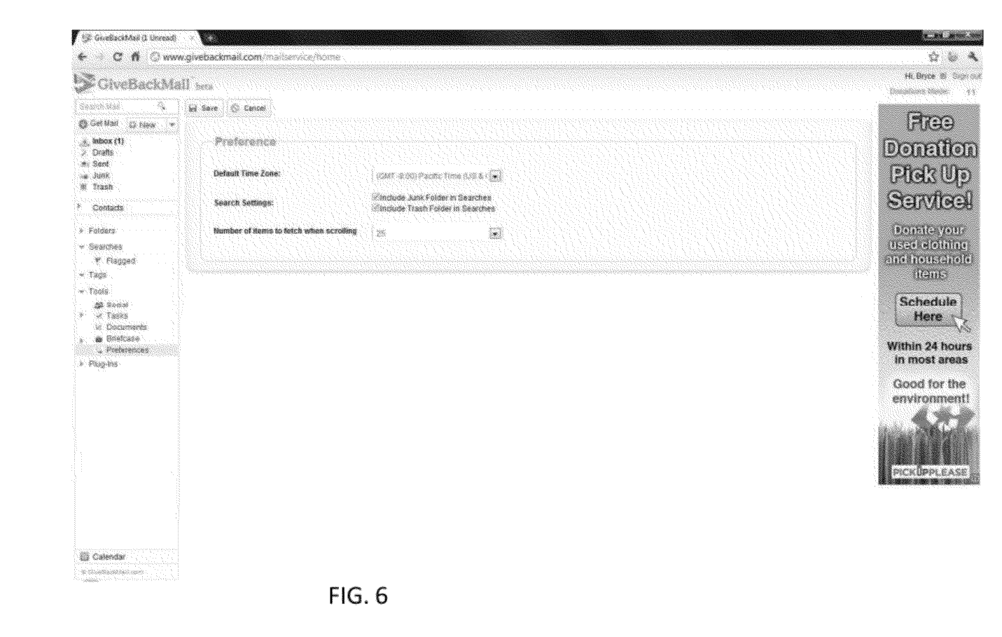

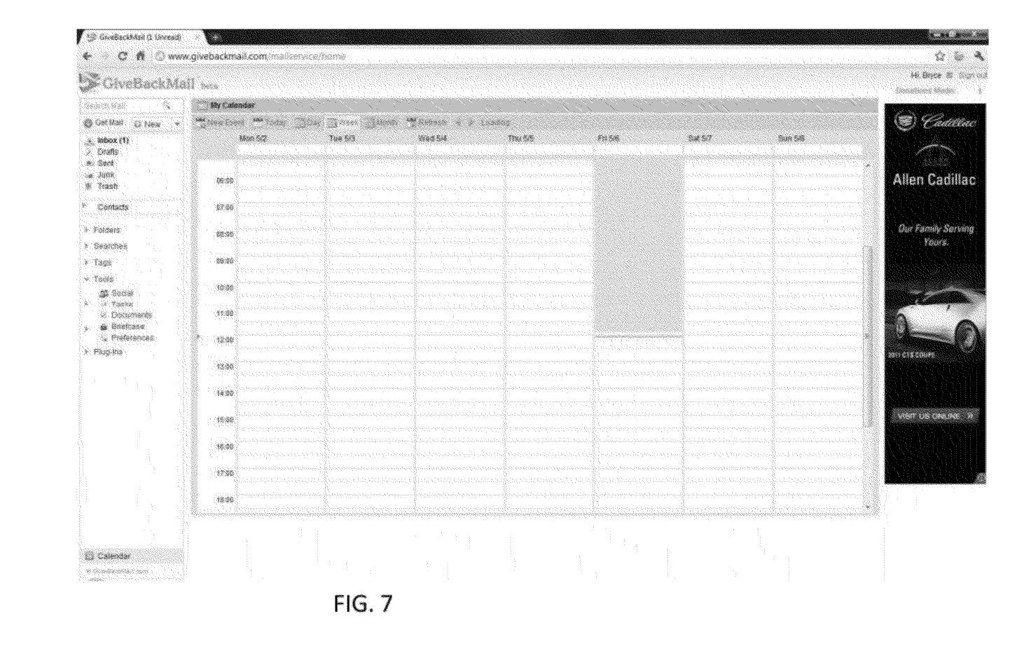

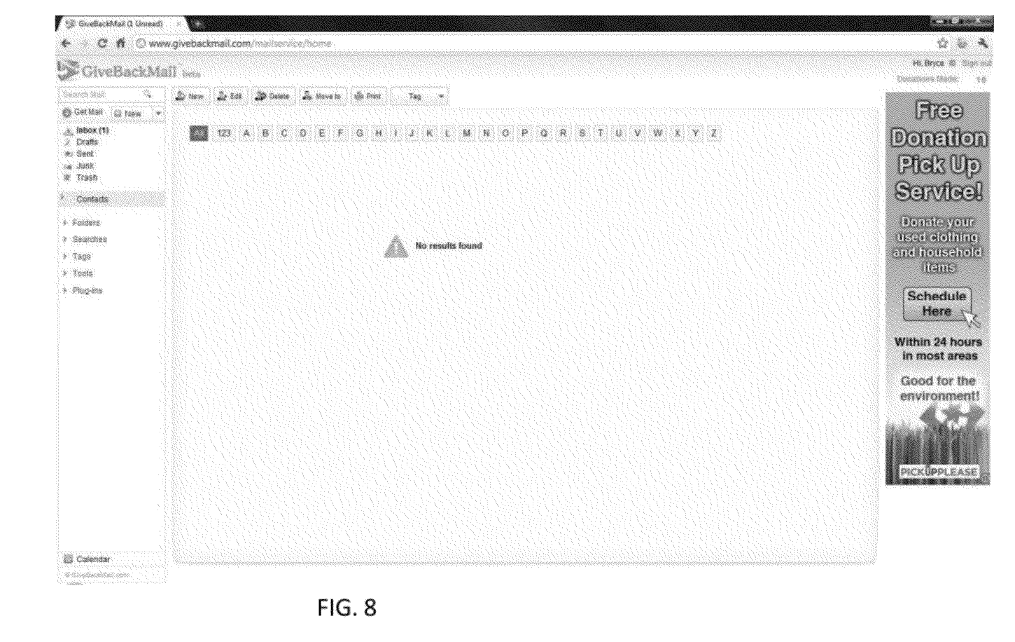

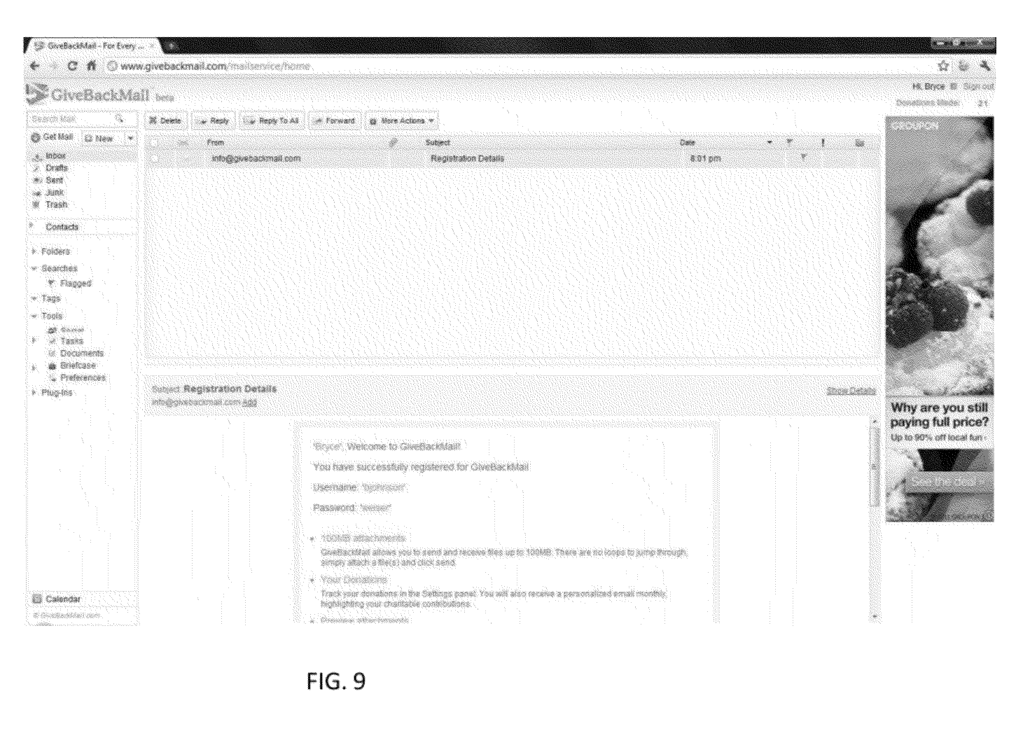

Exemplary user interfaces for email account and emailbox management may be seen in FIGS. 4 through 9.

As seen in FIGS. 4 through 9, the MUA is configured to present advertisements on the various interfaces of the MUA. Email systems that derive revenues from advertising (more specifically, from presenting advertisements on a user interface) are well known by those of skill in the art (see, e.g., U.S. Pub. App. Ser. No. 2008/0071613 (published Mar. 20, 2008; see also, e.g., gmail (www.gmail.google.com)). For this reason, this specification may focus on the processes and functionalities of the MAU associated with donating a portion of the advertising revenues derived from the user's use of the email client to a charity selected by a user of the system and associated with the email account.

In the preferred embodiment, the MUA is configured to present an advertisement to the user on its user interface. The advertisements may suitably refresh or change in response to inputs or commands provided by the user to the user interface. For instance, a new advertisement may be presented whenever the user navigates between the various interfaces of the MUA, logs in, views an incoming message, replies to an incoming message, forwards and incoming message, deletes a message from the emailbox, composes an outgoing message, sends an outgoing message, manages contacts (e.g., create, sort, or delete), manages the calendar (e.g., create sort or delete), or changes the account preferences. Preferably each displayed advertisement generates revenue based on its being presented to the user via the user interface and at least a portion (more than 0% and up to 100%) of the generated revenue may be provided to the charitable organization associated with the account. The portion of revenue may be provided to the charitable organization in real time or according to a payment schedule (e.g., monthly). Accordingly, the programming code of the MUA should be configured to: present an advertisement on the user interface; refresh or replace the advertisement in response to an input received (i.e., action taken) from the user; determine the amount of revenue generated via the presentation of the advertisement to the user; determine the charitable organization that is linked to the account via searching in the population of the database with indications of identifying information of the user associated with an indication of identifying information of the charitable organization; determine a portion of the amount of revenue generated to be provided to the charitable organization, and populate a database with an indication of identifying information of the portion of revenue in association with the charitable organization. An exemplary logic flow of the programming code for determining the amount of advertising revenue generated to be provided to the charitable organization linked to the account may be: upon a user input command to send a message, present or replace an advertisement to the user on the user interface and determine the charitable organization associated with the email account and populate a database with an indication that advertising revenue has been generated and an indication of identifying information of a portion of said revenue associated with an indication of identifying information of the charitable organization.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention. It should be apparent that further numerous structural modifications and adaptations may be resorted to without departing from the scope and fair meaning of the present invention as set forth hereinabove and as described herein below by the claims.

What is disclosed may be an electronic mail (email) system comprising:
a database populated with an indication of identifying information for at least one charitable organization in association with an indication of identifying information for an email account of a user;
an MUA for accessing the email account, the MUA being defined by programming code on a computer readable memory, the programming code configured to:
   display a first user interface with a first advertisement, the interface for receiving inputs from a user while composing an outgoing message;
   converting the outgoing message to an email format;
   send the outgoing message and display a second user interface with a second advertisements upon a message send command from the user; and,
   upon the message send command from the user, determine the charitable organization associated with the account via a search of the database and populate the database with an indication of a of at least a portion of revenue derived from displaying the second advertisement on the user interface in association with an indication of indentifying information of the charitable organization; and, programming code on a computer readable memory configured to:
   mine the database for indications of the portion of revenue derived from displaying the second advertisement and the associated charitable organization; and,
   determine the portion of revenue derived from displaying the second advertisement and the charitable organization from the corresponding indications; and,
   directing the portion to the charitable organization.

What is also disclosed may be an email system comprising:
a database populated with an indication of identifying information for at least one charitable organization in association with an indication of identifying information for an email account of a user;
an MUA for accessing the email account, the MUA being defined by programming code on a computer readable memory, the programming code configured to:
   display a first user interface with a first advertisement, the interface for receiving inputs from a user while viewing an email message;
   display a second user interface with a second advertisements upon a message close command from the user; and,
   upon the message close command from the user, determine the charitable organization associated with the account via a search of the database and populate the database with an indication of a of at least a portion of revenue derived from displaying the second advertisement on the user interface in association with an indication of indentifying information of the charitable organization; and,
programming code on a computer readable memory configured to:
   mine the database for indications of the portion of revenue derived from displaying the second advertisement and the associated charitable organization; and,
   determine the portion of revenue derived from displaying the second advertisement and the charitable organization from the corresponding indications; and,
   directing the portion to the charitable organization.

What is also disclosed may be an email client defined by program code on computer readable memory, wherein the program code is configured to:
retrieve an email message from an emailbox;
display the email message and an advertisement to a user on a user interface;
populate a database with a first indication of information identifying that the advertisement was displayed on the user interface in association with a second indication of information identifying a charitable organization, whenever the advertisement is displayed on the user interface; and
determine a charitable donation to be provided to the charitable organization that is based at least in part on the first indication of information.

What is also disclosed may be an email client defined by program code on computer readable memory, wherein the program code is configured to:
display the advertisement to a user on a user interface;
populate a database with a first indication of information identifying that the advertisement was displayed on the interface in association with a second indication of information identifying a charitable organization, whenever the advertisement is displayed on the second user interface; and
determine a charitable donation to be provided to the charitable organization that is based at least in part on the first indication of information.

What is also disclosed may be a method of making a charitable donation comprising the steps of:
Identifying a charitable organization selected by a user;
Presenting an advertisement to the user on a user interface of an email client;
Receiving payment for presenting the advertisement to the user; and,
Providing at least a portion of the payment to the charitable organization.

I claim:

1. An email client defined by program code on computer readable memory, wherein the program code is configured to:
retrieve an email message from an emailbox;
display the email message and an advertisement to a user on a user interface;
populate a database with a first indication of information identifying that the advertisement was displayed on the user interface in association with a second indication of information identifying a charitable organization, whenever the advertisement is displayed on the user interface; and
determine a charitable donation to be provided to the charitable organization that is based at least in part on the first indication of information.

2. The email client of claim 1 wherein the program code is further configured to:
send an email message according to a submission protocol;
display the advertisement to a user on a second user interface after sending said email message;
populate a database with a third indication of information identifying that the advertisement was displayed on the second user interface in association with the second indication of information identifying the charitable organization, whenever the advertisement is displayed on the second user interface; and
determine a charitable donation to be provided to the charitable organization that is based at least in part on the third indication of information.

3. The email client of claim 1 wherein the program code is further configured to:
manage at least one contact;
display the advertisement to a user on a contact management interface;
populate a database with a fourth indication of information identifying that the advertisement was displayed on the contact management interface in association with the second indication of information identifying the charitable organization, whenever the advertisement is displayed on the contact manager interface; and
determine a charitable donation to be provided to the charitable organization that is based at least in part on the fourth indication of information.

4. The email client of claim 1 wherein the program code is further configured to:
compose an email message;
display the advertisement to a user on a message composing interface;
populate a database with a fifth indication of information identifying that the advertisement was displayed on the message composing interface in association with the second indication of information identifying the charitable organization, whenever the advertisement is displayed on the second user interface; and
determine a charitable donation to be provided to the charitable organization that is based at least in part on the fifth indication of information.

5. The email client of claim 1 wherein the program code is further configured to:
manage at least one calendar;
display the advertisement to a user on a calendar management interface;
populate a database with a sixth indication of information identifying that the advertisement was displayed on the second user interface in association with the second indication of information identifying the charitable organization, whenever the advertisement is displayed on the second user interface; and
determine a charitable donation to be provided to the charitable organization that is based at least in part on the sixth indication of information.

6. An email client defined by program code on computer readable memory, wherein the program code is configured to:
display the advertisement to a user on a user interface;
populate a database with a first indication of information identifying that the advertisement was displayed on the interface in association with a second indication of information identifying a charitable organization, whenever the advertisement is displayed on the second user interface; and
determine a charitable donation to be provided to the charitable organization that is based at least in part on the first indication of information.

7. The email client of claim 6 wherein the interface is selected from the group consisting essentially of a message composing user interface, a message display user interface, a contact management user interface, a calendar management user interface, and a sent message user interface.

8. The email client of claim 7 wherein the program code is configured to allow the user to select the charitable organization.

9. A method of making a charitable donation comprising the steps of:
Associating a charitable organization with a user of an email client;
Presenting an advertisement to the user on a user interface of the email client;
Receiving payment for presenting the advertisement to the user; and,
Providing at least a portion of the payment to the charitable organization.

10. The method of claim 9 wherein the interface is selected from the group consisting essentially of a message composing user interface, a message display user interface, a contact management user interface, a calendar management user interface, and a sent message user interface.
